(19) United States
(12) Patent Application Publication
(10) Pub. No.: US 2015/0311812 A1
(43) Pub. Date: Oct. 29, 2015

(54) ACTIVE CLAMP FORWARD DC-DC CONVERTER CIRCUIT

(71) Applicant: KABUSHIKI KAISHA TOYOTA JIDOSHOKKI, Kariya-shi (JP)

(72) Inventor: Sergey MOISEEV, Aichi-ken (JP)

(73) Assignee: KABUSHIKI KAISHA TOYOTA JIDOSHOKKI, Kariya-shi (JP)

(21) Appl. No.: 14/694,268

(22) Filed: Apr. 23, 2015

(30) Foreign Application Priority Data
Apr. 28, 2014 (JP) 2014-092232

(51) Int. Cl. H02M 3/335

(52) U.S. Cl. CPC H02M 3/33546

(57) ABSTRACT

There is provided an active clamp forward DC-DC converter circuit that includes an insulated transformer having a primary coil and a switching circuit connected to the primary coil of the insulated transformer. The switching circuit includes a first circuit and a second circuit that is connected in parallel to the first circuit. The switching circuit further includes a first rectifying element or a second rectifying element or a third power storage element. The first circuit includes a first switching element and a second switching element that are connected in series. The second circuit includes a third switching element, a fourth switching element, a first power storage element and a second power storage element that are connected in series.

### BACKGROUND OF THE INVENTION

The present invention relates to an active clamp forward DC-DC converter circuit.

An active clamp forward DC-DC converter circuit (hereinafter referred to as ACF circuit) is known which has an insulated transformer T1, a power storage element C1 as an input capacitor, switching elements Q11, Q21 such as an N-channel MOSFET (metal-oxide semiconductor field-effect transistor), a power storage element Cr, rectifying elements D1, D2, an inductor L1, a power storage element C2 as an output capacitor, and a controller.

The following will describe the configuration of a primary circuit of the insulated transformer T1 in the ACF circuit. The power storage element C1 is connected to the junction between power input terminals IN1, IN2. The power input terminal IN1 and one terminal of the power storage element C1 are connected to one terminal of the primary coil of the insulated transformer T1. The other terminal of the primary coil of the insulated transformer T1 is connected to the junction between the drain of the switching element Q11 and the source of the switching element Q21. The drain of the switching element Q21 and one terminal of the power storage element Cr are connected to an auxiliary circuit that is parallel-connected to the switching element Q1. The junction between the source of the switching element Q11 and the other terminal of the power storage element Cr is connected to the other terminal of the power storage element C1 and the power input terminal IN2. The auxiliary circuit to which the drain of the switching element Q21 and the one terminal of the power storage element Cr are connected performs supplementary functions for the switching element Q11. Specifically, the auxiliary circuit resets the primary circuit by making the switching element Q21 on while the switching element Q11 is off and suppresses surge caused by excitation inductance that is present in the primary circuit of the insulated transformer T1. The controller transmits on/off signals to the gates of the switching elements Q11, Q21 to control the switching elements Q11, Q21.

The following will describe the configuration of a secondary circuit of the insulated transformer T1. The anodes of the rectifying elements D1, D2 are connected to one and the other terminals of the secondary coil of the insulated transformer T1, respectively. The cathodes of the rectifying elements D1, D2 are both connected to one terminal of the inductor L1. The other terminal of the inductor L1 is connected to one terminal of the power storage element C2 and an output terminal OUT1. The other terminal of the power storage element C2 is connected to the anode of the rectifying element D2 and an output terminal OUT2. In the secondary circuit of the insulated transformer T1, electric power is accumulated through the rectifying elements D1, D2 and the inductor L1 and the accumulated electric power is output after smoothing the ripples by the power storage element C2.

If an input voltage to the above-described ACF circuit from a power source is high, the voltage applied to the switching elements Q11, Q21 is also high. To resist such high input voltage, the switching elements Q11, Q21 may be configured to have a high rated voltage, but with the sacrifice of increased cost of the ACF circuit. As a method to solve such problem, a configuration of an ACF circuit has been known in which each of the switching elements Q11, Q21 is formed by a plurality of switching elements each having low rated voltage. That is, the source of an additional switching element Q12 is connected to the drain of the switching element Q11, the drain of the switching element Q12 is connected to the source of the switching element Q21 and the other terminal of the primary coil of the transformer T1, the drain of the switching element Q21 is connected to the source of another additional switching element Q22, and the drain of the switching element Q22 is connected to the one terminal of the power storage element Cr. Such serial connection of the switching elements can reduce the voltage applied to each switching element because the voltages applied to the switching elements Q1, Q2 are dispersed by the additional switching elements Q12, Q22. As a result, the ACF circuit can dispense with switching elements that have high rated voltage and hence are costly.

According to the above configuration, the voltage applied to each of the switching elements Q11, Q12, Q21, Q22 can be reduced. If the switching elements Q11, Q12, Q21, Q22 have variations in characteristics, however, there is a fear that voltage variation occurs in the switching elements Q11, Q12, Q21, Q22, accordingly.

Japanese Patent Application Publication No. 2009-165119 discloses a resonant converter 2 having a first power storage element C1, a second power storage element C2, a third power storage element C3, and first, second, third, and fourth controllable bidirectional power semiconductor switches S1, S2, S3, S4. The second power storage element C2 is connected to the first power storage element C1 in parallel thereto. The controllable bidirectional power semiconductor switches S1, S2, S3, S4 are connected in series to each other. The first and second power storage elements C1, C2 are connected to the first and fourth controllable bidirectional power semiconductor switches S1, S4, respectively.

The present invention is directed to providing an active clamp forward DC-DC converter circuit that permits the use of switching elements having a lower rated voltage by controlling the voltage applied to a plurality of switching elements for the active clamp forward DC-DC converter circuit within a determined voltage range.

### SUMMARY OF THE INVENTION

There is provided an active clamp forward DC-DC converter circuit that includes an insulated transformer having a primary coil and a switching circuit connected to the primary coil of the insulated transformer. The switching circuit includes a first circuit, a second circuit that is connected in parallel to the first circuit, and a first rectifying element. The first circuit includes a first switching element and a second switching element that are connected in series. The second circuit includes a third switching element, a fourth switching element, a first power storage element and a second power storage element that are connected in series. An anode of the first rectifying element is connected to a junction between the first and second switching elements. A cathode of the first rectifying element is connected to a junction between the first and second power storage elements.

There is provided another active clamp forward DC-DC converter circuit that includes an insulated transformer having a primary coil and a switching circuit connected to the primary coil of the insulated transformer. The switching circuit includes a first circuit, a second circuit that is connected in parallel to the first circuit, and a second rectifying element. The first circuit includes a first switching element and a second switching element that are connected in series. The second circuit includes a third switching element, a fourth switching element, a first power storage element and a second power storage element that are connected in series. A cathode of the second rectifying element is connected to a junction between the third and fourth switching elements. An anode of the second rectifying element is connected to a junction between the first and second power storage elements.

There is provided still another active clamp forward DC-DC converter circuit that includes an insulated transformer having a primary coil and a switching circuit connected to the primary coil of the insulated transformer. The switching circuit includes a first circuit, a second circuit that is connected in parallel to the first circuit, a first rectifying element, a second rectifying element, and a third power storage element. The first circuit includes a first switching element and a second switching element that are connected in series. The second circuit includes a third switching element, a fourth switching element, a first power storage element and a second power storage element that are connected in series. An anode of the first rectifying element is connected to a junction between first and second switching elements. A cathode of the first rectifying element is connected to a junction between the first and second power storage elements. A cathode of the second rectifying element is connected to a junction between third and fourth switching elements. An anode of the second rectifying element is connected to a junction between the first and second power storage elements. The third power storage is connected to a junction between the first and second switching elements and the junction between the third and fourth switching elements.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a circuit diagram showing an active clamp forward DC-DC converter circuit according to an embodiment of the present invention;

FIG. 2 is a circuit diagram of the active clamp forward DC-DC converter circuit of FIG. 1, showing the operation of the circuit in mode 1; and

FIG. 3 is a circuit diagram of the active clamp forward DC-DC converter circuit of FIG. 1, showing the operation of the circuit in mode 3 and mode 4.

### DETAILED DESCRIPTION OF THE EMBODIMENTS

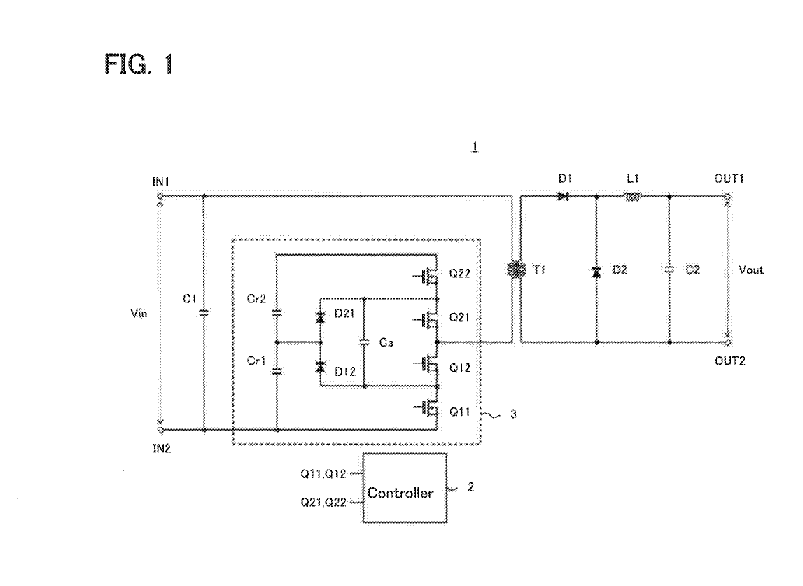

The following will describe the circuit diagram of the active clamp forward DC-DC converter circuit (hereinafter referred to as ACF circuit) according to an embodiment of the present invention with reference to the drawings. Referring to FIG. 1, the ACF circuit includes an insulated transformer T1, a power storage element C1 as an input power storage element, switching elements Q11, Q12, Q21, Q22 such as an N-channel MOSFET or first, second, third, fourth switching elements, respectively, power storage elements Cr1, Cr2 or first, second power storage elements, respectively, rectifying elements D12, D21 or first, second rectifying elements, respectively, a power storage element Ca or third power storage element, rectifying elements D1, D2, an inductor L1, a power storage element C2 as an output capacitor, and a controller 2.

The following will describe the configuration of the primary circuit of the insulated transformer T1 in the ACF circuit. The power storage element C1 is connected across power input terminals IN1 and IN2. The power input terminal IN1 and one terminal of the power storage element C1 are connected to one terminal of the primary coil of the insulated transformer T1.

The other terminal of the primary coil of the insulated transformer T1 is connected to the junction between the drain of the switching element Q12 and the source of the switching element Q21 and the drain of the switching element Q11 is connected to the source of the switching element Q22, thus a first circuit being formed. The drain of the switching element Q21 is connected to the source of the switching element Q22, the drain of the switching element Q22 to one terminal of the power storage element Cr2, the other terminal of the power storage element Cr2 to one terminal of the power storage element Cr1, and the other terminal of the power storage element Cr1 to the source of the switching element Q11, respectively, thus a second circuit being formed.

The junction between the one terminal of the power storage element Cr1 and the other terminal of the power storage element Cr2 is connected to the junction between the cathode of the rectifying element D12 and the anode of the rectifying element D21. One terminal of the power storage element Ca is connected to the junction among the cathode of the rectifying element D21, the drain of the switching element Q21, and the source of the switching element Q22. The other terminal of the power storage element Ca is connected to the junction among the anode of the rectifying element D12, the drain of the switching element Q11, and the source of the switching element Q12.

The junction between the source of the switching element Q11 and the other terminal of the power storage element Cr1 is connected to the other terminal of the power storage element C1 and the power input terminal IN2. In FIG. 1, the part of the ACF circuit that is enclosed by dotted line is a switching circuit 3 that includes the switching elements Q11, Q22 and an auxiliary circuit that performs supplementary functions for the switching elements Q11, Q12. Specifically, the auxiliary circuit functions to turn on the switching elements Q21, Q22 while the switching elements Q11, Q12 are off thereby to reset the primary circuit of the insulated transformer T1 and also to suppress surge caused by excitation inductance that is present in the primary coil of the insulated transformer T1. The power storage elements Cr1, Cr2 are provided instead of a single power storage element such as Cr that is provided in the ACF circuit of the background art to separate the voltage applied to the power storage elements Cr1, Cr2. The capacitance of each of the power storage elements Cr1, Cr2 should preferably be half the capacitance of the power storage element Cr.

The controller 2 is connected to the gates of the respective switching elements Q11, Q12, Q21, Q22 through signal lines for transmitting on/off signals. In the embodiment, the switching elements Q11, Q12, Q21, Q22 use an N-channel MOSFET, but may not be limited to the N-channel MOSFET.

The following will describe the configuration of the secondary circuit of the insulated transformer T1 in the ACF circuit. One terminal of the secondary circuit of the insulated transformer T1 is connected to the anode of the rectifying element D1. The other terminal of the secondary circuit of the insulated transformer T1 is connected to the anode of the rectifying element D2. The cathodes of the rectifying element D1, D2 are connected to one terminal of the inductor L1. The other terminal of the inductor L1 is connected to one terminal of the power storage element C2 and the output terminal OUT1. The other terminal of the power storage element C2 is connected to the anode of the rectifying element D2 and the output terminal OUT2. In the secondary circuit of the insulated transformer T1, electric power is accumulated through the rectifying elements D1, D2 and the inductor L1 and the accumulated electric power is output after smoothing the ripples by the power storage element C2.

The following will describe operation of the ACF circuit 1. The controller 2 controls the on/off operation of the switching elements Q11, Q12, Q21, Q22 at a predetermined interval of time T and the ACF circuit outputs a target output voltage Vout, accordingly. The interval of time T corresponds to the sum of the periods of time T1, T2, T3, and T4 and such period of time will be described later. In the first period of time T1 of on/off control, the switching elements Q11, Q12 are turned on and the switching elements Q21, Q22 are turned off. In the second period of time T2, the switching elements Q11, Q12 are turned off from on. In the third period of time T3, the switching elements Q21, Q22 are turned on from off. Finally, in the fourth period of time T4, the switching elements Q21, Q22 are turned off from on.

In the period of time T1 (or the period of mode 1), the input voltage Vin is applied across the primary circuit of the insulated transformer T1, so that a current flows through the primary coil of the insulated transformer T1 and the switching elements Q11, Q12. Then, a voltage is induced across the terminals of the secondary coil of the insulated transformer T1 which corresponds to the product of the input voltage Vin and the winding turns ratio N and electric power is transmitted from the primary circuit to the secondary circuit. Thus, the electric power output occurs in the period of mode 1.

In the period of time T2 (or the period of mode 2), capacitances CQ11, CQ12, CQ21, CQ22 of the respective switching elements Q11, Q12, Q21, Q22 are charged. Thus, switching is performed in the period of mode 2.

Regarding the period of time T3 (or the periods of modes 3, 4), in the period of mode 3, the electric power is transmitted to the power storage elements Cr1, Cr2 by the current flowing through the primary coil of the transformer T1, the switching elements Q21, Q22, and the power storage elements Cr1, Cr2. Thus, resetting is performed in the period of mode 3. In the period of mode 4, the voltages of the power storage elements Cr1, Cr2 increase, with the result that current flows in the direction opposite to the current flowing in the period of mode 1 though the power storage elements Cr2, Cr1, the switching elements Q22, Q21, and the primary coil of the insulated transformer T1.

Regarding the period of time T4 (or the period of mode 5, 6), in the period of mode 5, the capacitances CQ11, CQ12, CQ21, CQ22 of the respective switching elements Q11, Q12, Q21, Q22 are discharged. In the period of mode 6, current flows through the switching elements Q12, Q11 and the primary coil of the insulated transformer T1. Thus, switching is performed in the periods of modes 5 and 6.

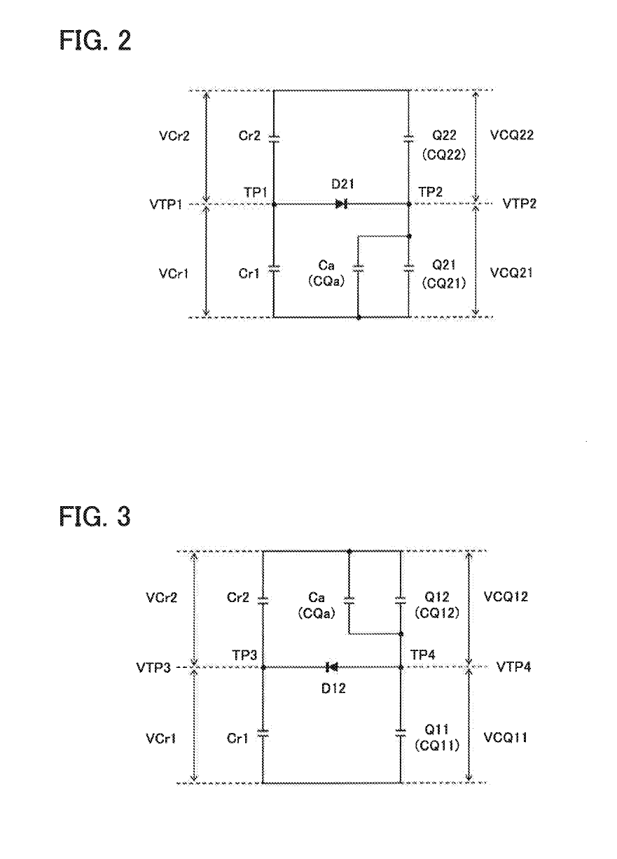

The following will describe the operation in the period of time T1 of mode 1 in details. Referring to FIG. 2, in the period of time T1 of mode 1, the switching elements Q11, Q12 are turned on and the switching elements Q21, Q22 are turned off, with the result that current flows through the primary coil of the insulated transformer T1 to the switching elements Q11, Q12. Then, the switching circuit 3 of FIG. 1 becomes equivalent to a circuit formed by the power storage elements Cr1, Cr2, the switching elements Q21, Q22, the rectifying element D21, and the power storage element Ca, as shown in FIG. 2.

It is noted that in FIG. 2, the switching elements Q21, Q22 are shown to be equivalent to power storage elements having capacitances CQ21, CQ22, respectively. In the case that the switching elements Q21, Q22 use a MOSFET, the capacitances CQ21, CQ22 of the respective switching elements Q21, Q22 are parasitic capacitances that are determined depending on the electrostatic capacitance Cgs of gate-source oxide film, the electrostatic capacitance Cgd of gate-drain oxide film, and the electrostatic capacitance Cds of the junction of a build-in rectifying element between source-drains.

In the description of the embodiment, the capacitances CQ21, CQ22 are explained by using parasitic capacitance. However, in practical circuits, an external snubber circuit such as CR snubber circuit or CDR snubber circuit may be connected across the drain-sources of the respective switching elements Q21, Q22. Therefore, the capacitances CQ21, CQ22 should be determined with the capacitance of the snubber circuit taken in consideration.

As shown in FIG. 2, the voltages VCQ21, VCQ22 are the voltages across the drain-sources of the switching elements Q21, Q22, respectively. The voltages VCr1, VCr2 are the voltages across the terminals of the power storage elements Cr1, Cr2, respectively.

In FIG. 2, if the power storage elements Cr1, Cr2 have substantially the same capacitance, the voltage VCr1 is substantially the same as the voltage VCr2. Therefore, the voltage is divided and the divided voltages are applied to the switching elements Q21, Q22, respectively.

If the switching elements Q21, Q22 in the circuit shown in FIG. 2 have a variation in characteristics, the following two cases can be thought. In the case (1), the capacitance CQ21 is greater than the capacitance CQ22. In the case, the circuit of FIG. 2 can dispense with the power storage element Ca. In the case (2), the capacitance CQ21 is smaller than the capacitance CQ22 and the sum of the capacitance CQ21 and the capacitance CQa of the power storage element Ca is greater than the capacitance CQ22.

In the case (1), the capacitance CQ21 is greater than the capacitance CQ22 without the power storage element Ca, with the result that an expression: VCQ21/VCQ22=CQ22/CQ21 is established and the voltage VTP1 at the junction TP1 is greater than the voltage VTP2 at the junction TP2. Then, the rectifying element D21 is turned on and, therefore, an expression: VCQ21=(VCr1+VCr2)/2 (or a predetermined voltage) is established. That is, if there is variation in characteristics in the switching elements Q21, Q22 and the case (1) is established, the voltage applied to each of the switching elements Q21, Q22 can be less than expressed by (VCr1+VCr2)/2. Since the voltages for application to the switching elements Q21, Q22 are lower than that in the ACF circuit according to the background art, a switching element having a lower rated voltage can be used. Since the switching element having a lower rated voltage generally has better characteristics than the switching element having a higher rated voltage, the use of the former switching element can reduce the switching loss and the body size as compared to a case in which a switching element having higher rated voltage is used.

In the case (2) in which the capacitance CQ21 is smaller than the capacitance CQ22 and the power storage element Ca is connected in parallel to the switching element Q21, the sum of the capacitance CQ21 and the capacitance CQa is greater than the capacitance CQ22. Therefore, an expression: VCQ21/VCQ22=CQ22/(CQ21+CQa) is established. Then, the voltage VTP1 at the junction TP1 is greater than the voltage VTP2 at the junction TP2. As a result, the rectifying element D21 is turned on and the voltage VCQ21 becomes substantially the same as the voltage (VCr1 +VCr2)/2 (or a predetermined voltage). That is, even if the switching elements Q21, Q22 have a variation in characteristics and if the case (2) is established, the voltages applied to the switching elements Q21, Q22 are controlled not to be more than not to exceed the voltage (VCr1+VCr2)/2. Since the voltages applied to the switching elements Q21, Q22 are lower than that in the ACF circuit according to the background art, a switching element having lower rated voltage can be used. Since the switching element having a lower rated voltage generally has better characteristics than a switching element having higher rated voltage, the use of such switching element can reduce switching loss and the body size as compared to a case in which a switching element having higher rated voltage is used.

The following will describe the operation of the AFC circuit in the period of time T3 of modes 3 and 4 in details. In the period of time T3 of modes 3 and 4, the switching elements Q21, Q22 are turned on and the switching elements Q11, Q12 are turned off, with the result that the switching circuit 3 of FIG. 1 becomes equivalent to a circuit formed by the power storage elements Cr1, Cr2, the switching elements Q11, Q12, the rectifying element D12, and the power storage element Ca, as shown in FIG. 3.

In FIG. 3, the switching elements Q11, Q12 are shown to be equivalent to power storage elements having the capacitances CQ11, CQ12, respectively. In the case that the switching elements Q11, Q12 use a MOSFET, the capacitances CQ11, CQ12 of the respective switching elements Q11, Q12 are parasitic capacitance, that are determined depending on the electrostatic capacitance Cgs of gate-source oxide film, the electrostatic capacitance Cgd of gate-drain oxide film, and the electrostatic capacitance Cds of the junction of a build-in rectifying element between source-drains.

In the description of the embodiment, an external snubber circuit such as CR snubber or CDR snubber circuit may be connected across the drain-sources of the respective switching elements Q11, Q12. Therefore, the capacitances CQ11, CQ12 should preferably be determined in consideration of capacitance of a snubber circuit.

As shown in FIG. 3, the voltages VCQ11, VCQ12 are the voltages across the drain-sources of the switching elements Q11, Q12, respectively. The voltages

VCr1, VCr2 are the voltages across the terminals of the power storage elements Cr1, Cr2, respectively.

In FIG. 3, if the power storage elements Cr1, Cr2 have substantially the same capacitance, the voltage VCr1 is substantially the same as the voltage VCr2. Therefore, the voltage is divided and the divided voltages are applied to the switching elements Q11, Q12, respectively.

If the switching elements Q11, Q12 in the circuit shown in FIG. 3 have a variation in characteristics, there could be two cases (3), (4) as follows. In the case (3), the capacitance CQ11 is greater than the capacitance CQ12. In this case, the circuit of FIG. 3 can dispense with the power storage element Ca. In the case (4), the capacitance CQ11 is smaller than the capacitance CQ12 and the sum of the capacitance CQ11 and the capacitance CQa of the power storage element Ca is greater than the capacitance CQ12.

In the case (3), the capacitance CQ11 is larger than the capacitance CQ12 without the power storage element Ca, with the result that an expression: VCQ11/VCQ12=CQ12/CQ11 is established and in FIG. 3, the voltage VTP3 at the junction TP3 is larger than the voltage VTP4 at the junction TP3. Then, the rectifying element D12 is turned on and, therefore, an expression: VCQ11=(VCr1+VCr2)/2 (or a predetermined voltage) is established. That is, if the switching elements Q11, Q12 have a variation in characteristics and if the case (3) is established, the voltage applied to each of the switching elements Q11, Q12 can be controlled not to be more than (VCr1 +VCr2)/2. Since the voltages for application to the switching elements Q11, Q12 are lower than that in the ACF circuit according to the background art, a switching element having a lower rated voltage can be used. Since the switching element having a lower rated voltage generally has better characteristics than the former switching element, the use of the former switching element can reduce the switching loss and the body size as compared to a case in which a switching element having a higher rated voltage is used.

In the case (4) in which the capacitance CQ11 is smaller than the capacitance CQ12 and the power storage element Ca is connected in parallel to the switching element Q11, the sum of the capacitance CQ21 and the capacitance CQa is greater than the capacitance CQ22. Therefore, an expression: VCQ11/VCQ12=CQ12/(CQ11+CQa) is established. Then, the voltage VTP3 at the junction TP3 (FIG. 3) is smaller than the voltage VTP4 at the junction TP4. As a result, the rectifying element D12 is turned on and the voltage VCQ11 becomes substantially the same as the voltage (VCr1+VCr2)/2 (or a predetermined voltage). That is, even if the switching elements Q11, Q12 have a variation in characteristics and if the case (4) is established, the voltages applied to the switching elements Q21, Q22 are controlled not to be more than not to exceed the voltage (VCr1+VCr2)/2. Since the voltages applied to the switching elements Q11, Q12 are lower than in the ACF circuit according to the background art, a switching element having lower rated voltage can be used. Since a switching element having lower rated voltage generally has better characteristics than a switching element having higher rated voltage, the use of a switching element having a lower rated voltage can reduce the switching loss and the body size as compared to that of a switching element having a higher rated voltage.

The present invention is not limited to the above embodiment and may be modified within the scope of the present invention.

What is claimed is:

1. An active clamp forward DC-DC converter circuit comprising:
an insulated transformer having a primary coil; and
a switching circuit connected to the primary coil of the insulated transformer, the switching circuit including a first circuit, a second circuit that is connected in parallel to the first circuit, and a first rectifying element, the first circuit including a first switching element and a second switching element that are connected in series, the second circuit including a third switching element, a fourth switching element, a first power storage element and a second power storage element that are connected in series, an anode of the first rectifying element being connected to a junction between the first and second switching elements, a cathode of the first rectifying element being connected to a junction between the first and second power storage elements.

2. The active clamp forward DC-DC converter circuit according to claim 1, wherein the switching circuit further includes a third power storage element that is connected to the junction between the first and second switching elements and a junction between the third and fourth switching elements.

3. An active clamp forward DC-DC converter circuit comprising:
an insulated transformer having a primary coil; and
a switching circuit connected to the primary coil of the insulated transformer, the switching circuit including a first circuit, a second circuit that is connected in parallel to the first circuit, and a second rectifying element, the first circuit including a first switching element and a second switching element that are connected in series, the second circuit including a third switching element, a fourth switching element, a first power storage element and a second power storage element that are connected in series, a cathode of the second rectifying element being connected to a junction between the third and fourth switching elements, an anode of the second rectifying element being connected to a junction between the first and second power storage elements.

4. The active clamp forward DC-DC converter circuit according to claim 3, wherein the switching circuit further includes a third power storage element that is connected to a junction between the first and second switching elements and the junction between the third and fourth switching elements.

5. An active clamp forward DC-DC converter circuit comprising:
an insulated transformer having a primary coil; and
a switching circuit connected to the primary coil of the insulated transformer, the switching circuit including a first circuit, a second circuit that is connected in parallel to the first circuit, a first rectifying element, a second rectifying element, and a third power storage element, the first circuit including a first switching element and a second switching element that are connected in series, the second circuit including a third switching element, a fourth switching element, a first power storage element and a second power storage element that are connected in series, an anode of the first rectifying element being connected to a junction between first and second switching elements, a cathode of the first rectifying element being connected to a junction between the first and second power storage elements, a cathode of the second rectifying element being connected to a junction between third and fourth switching elements, an anode of the second rectifying element being connected to a junction between the first and second power storage elements, the third power storage being connected to a junction between the first and second switching elements and the junction between the third and fourth switching elements.
